(19) United States
(12) Patent Application Publication
(10) Pub. No.: US 2012/0327948 A1
(43) Pub. Date: Dec. 27, 2012

(54) ADJUSTMENT OF NEGATIVE WEIGHTS IN WEIGHTED ROUND ROBIN SCHEDULING

(75) Inventors: Govindarajan Mohandoss, Bangalore (IN); Santosh Narayanan, Bangalore (IN); Rayesh Kashinath Raikar, Ankola (IN); Prabhakar Ballapalle, Bangalore (IN)

(73) Assignee: LSI Corporation, Milpitas, CA (US)

(21) Appl. No.: 13/165,852

(22) Filed: Jun. 22, 2011

(51) Int. Cl. H04L 12/56

(52) U.S. Cl. 370/412

(57) ABSTRACT

In one embodiment, a network processor services a plurality of queues having data using weighted round robin scheduling. Each queue is assigned an initial weight based on the queue's priority. During each cycle, an updated weight is generated for each queue by adding the corresponding initial weight to a corresponding previously generated decremented weight. Further, each queue outputs as many packets as it can without exceeding its updated weight. As each packet gets transmitted, the updated weight is decremented based on the number of blocks in that packet. If, after those packets are transmitted, the decremented weight is still positive and the queue still has data, then one more packet is transmitted, no matter how many blocks are in the packet. When a decremented weight becomes negative, the weights of the remaining queues are increased to restore the priorities of the queues as set by the initial weights.

### BACKGROUND OF THE INVENTION

1. Field of the Invention

The present invention relates to network processors, and, more specifically but not exclusively, to servicing of data queues in network processors.

2. Description of the Related Art

A conventional network processor typically receives a plurality of different classes of data packets, where each class of data packet corresponds to a different priority level. In processing received data packets, the network processor determines the particular class to which each data packet corresponds. The data packets are then stored in a plurality of data queues such that each data packet is stored in the data queue corresponding to the data packet's class. To maintain a desired quality of service (QoS), the network processor services the data queues such that data queues corresponding to higher priority level packets are given preferential treatment over data queues corresponding to lower priority level packets.

A number of different methods have been developed to implement preferential treatment for higher-priority data queues. For example, in one method, the network processor services the data queues in order from highest priority level to lowest priority level. In this method, the network processor determines the highest-priority data queue in which data is stored, and services that data queue such that all data packets stored in the data queue are output. Once all data packets have been output from the data queue being serviced, the network processor repeats this process. Thus, for each repetition, the network processor determines the highest-priority data queue in which data is stored, and services that data queue such that all data packets stored in that data queue are output.

In another method, the data queues are serviced in a weighted round robin manner. In this method, all of the data queues in which data is stored are serviced in a service cycle. The data queues having data are serviced in order from first to last, where the order of servicing may correspond to the priority level of the data queues (e.g., highest priority to lowest priority) or may be independent of the priority level of the data queues.

Each data queue is assigned a weight that corresponds to the desired number of data packets or data blocks that should be output from the data queue during each service cycle. The weights are selected based on the priority level of the data queue. Data queues corresponding to higher priority levels are assigned larger weights than data queues corresponding to lower priority levels. Thus, in each service cycle, data queues corresponding to higher priority levels output a greater number of data packets or data blocks than data queues corresponding to lower priority levels (assuming that the higher-priority data queues have a sufficient number of data packets or data blocks to output). A discussion of one particular type of weighted round robin technique, referred to as deficit weighted round robin (or simply deficit round robin), may be found, for example, in Shreedhar and Varghese, “Efficient Fair Queuing Using Deficit Round-Robin” I.E.E.E. ACM Transactions on Networking, Vol. 4, No. 3, June 1996, pgs. 375-385, the teachings of which are incorporated herein by reference in their entirety.

### SUMMARY OF THE INVENTION

In one embodiment, the present invention is a processor-implemented method for servicing data queues in a weighted round robin (WRR) manner. The method comprises (a) transmitting one or more packets from each of two or more data queues having data and decrementing a current weight for each data queue, (b) determining that a current weight for a first data queue has a negative value, and (c) adjusting the current weight for at least one other data queue based on a magnitude of the current weight for the first data queue. In another embodiment, the present invention is a processor adapted to implement this method.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified schematic of one implementation of a weighted round robin scheduling operation performed by a scheduler of a network processor;

FIG. 2 shows Table I, which illustrates an exemplary servicing of four data queues using deficit weighted round robin scheduling;

FIG. 3 shows Table II, which illustrates an exemplary servicing of four data queues using weighted round robin scheduling of the present invention;

FIG. 4 shows a simplified flow diagram according to one embodiment of the present invention that may be used to adjust weights when a decremented weight becomes negative;

FIG. 5 shows Table III, which illustrates an exemplary servicing of four data queues using weighted round robin scheduling and adjustment of weights according to one embodiment of the present invention; and

FIG. 6 shows pseudocode according to one embodiment of the present invention that may be used to adjust data queue weights when a decremented weight becomes negative.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Deficit Weighted Round Robin (DWRR) Scheduling

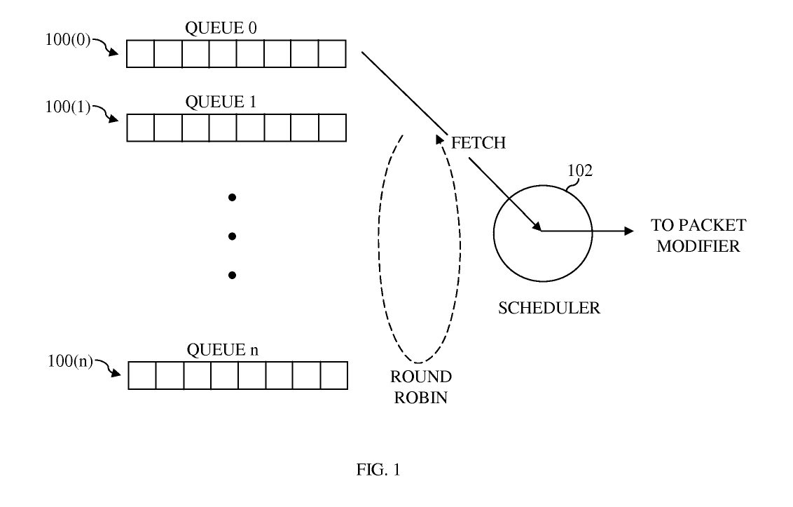

FIG. 1 shows a simplified schematic diagram of one implementation of a weighted round robin (WRR) scheduling operation performed by a scheduler 102 of a network processor. In FIG. 1, scheduler 102 performs scheduling for (n+1) data queues 100(0)-100(n), where n≧1. Data queues 100 each store a plurality of data packets as indicated by the plurality of squares in each data queue 100(i). Although not illustrated in FIG. 1, the size of the data packets stored in each data queue 100(i) may vary from one data packet to the next. When implemented in an application such as Ethernet, the packet sizes stored in each data queue 100(i) may vary from 64 bytes to 9,600 bytes.

Data queues 100 are serviced in a round robin manner, such that, in each service cycle t, data queues 100 are serviced in order from data queue 100(0) to data queue 100(n). In servicing each data queue 100(i), the packets at the head of the data queue 100(i) are output first. If, during a service cycle, any of the data queues 100 are empty, then the empty data queue 100(i) is not serviced, and servicing proceeds to the next data queue 100(i+1).

Each data queue 100(i) is assigned an initial weight wᵢ(0) that represents the desired number of packets that should be output the first time that data queue 100(i) is serviced. The initial weights wᵢ(0) are set based on the priority levels of the data packets that are stored in the respective data queues 100. Thus, the initial weight wᵢ(0) of a high-priority data queue 100(i) will be greater than the initial weight wᵢ(0) of a low-priority data queue 100(i).

Although data queues 100 output data their respective data in the granularity of packets, scheduler 102 determines the number of packets to output from each data queue 100(i) in a service cycle t using a block-level granularity. Performing scheduling using a block-level granularity, as opposed to a packet-level granularity, allows scheduler 102 to take into account the size of the packets when determining how many packets to output from each data queue 100(i) in each service cycle t. To perform scheduling using a block-level granularity, each initial weight wᵢ(0) is set to a specified number of data blocks. Note that, as used herein, the term block refers to a unit of data, such as a byte or a collection of bytes, wherein the block size is chosen such that each of the various packet sizes comprises an integer number of blocks. For instance, a block size of 64 bytes may be chosen such that each 64-byte packet contains one 64-byte block, each 128-byte packet contains two 64-byte blocks, and so on.

In a traditional weighted round robin scheduling approach, referred to as “deficit weighted round robin” scheduling, in each new service cycle t, an updated weight wᵢ(t) is calculated for each data queue 100(i) that is to be serviced by adding a corresponding decremented weight wᵢ(t−1) generated during the previous service cycle (t−1) to the initial weight wᵢ(0) for the data queue 100(i) (i.e., wᵢ(t)=wᵢ(0)+wᵢ(t−1)). Note that, in the first service cycle t=1, the previous decremented weight wᵢ(t−1) may be initialized to zero. Each time a data queue 100(i) is serviced, the data queue's corresponding updated weight wᵢ(t) is decremented by one for every block of every packet'output from the data queue 100(i) to generate a decremented weight wᵢ(t) for the service cycle t.

In deficit weighted round robin scheduling, in each service cycle t, each data queue 100(i) that is serviced outputs as many packets as it can without exceeding its current weight wᵢ(t). This means that a data queue 100(i) might not transmit its entire allocation of blocks if (i) there are no more packets remaining in the data queue 100(i) or (ii) the number of blocks in the next packet in the data queue 100(i) is larger than the number of blocks remaining in the data queue's allocation for that service cycle t.

For example, suppose that (i) a data queue 100(i) has an updated weight wᵢ(t)=3 blocks and (ii) the data queue stores two packets, where each packet comprises one 64-byte block (i.e., each packet has a size of 64-bytes). In this case, the data queue 100(i) outputs the only two packets stored in the data queue. Now suppose that (i) a data queue 100(i) has an updated weight wᵢ(t)=3 blocks and (ii) the data queue 100(i) stores two packets, where each packet comprises two 64-byte blocks (i.e., each packet has a size of 128-bytes). In this case, the data queue 100(i) outputs the first two-byte packet, resulting in a decremented weight wᵢ(t)=1 block. Outputting the next packet in the data queue 100(i), which has two blocks, would exceed the decremented weight wᵢ(t)=1 block. Thus, data queue 100(i) does not transmit the next packet during the current service cycle t.

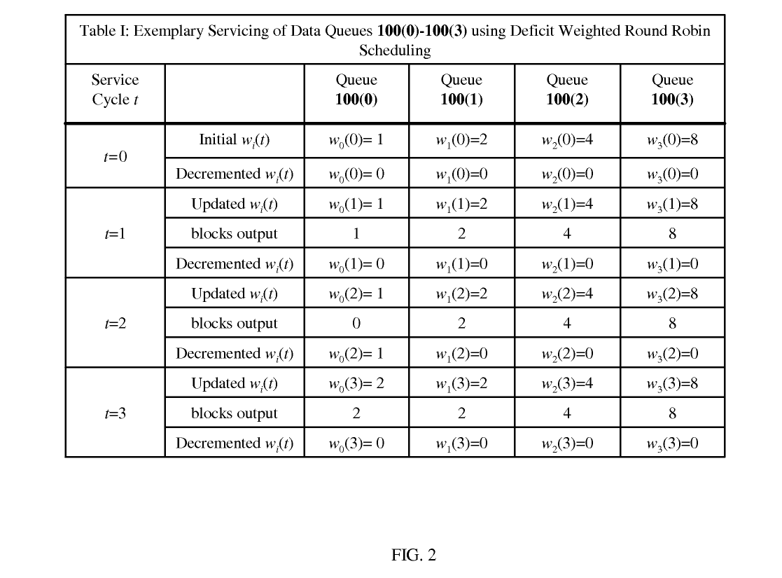

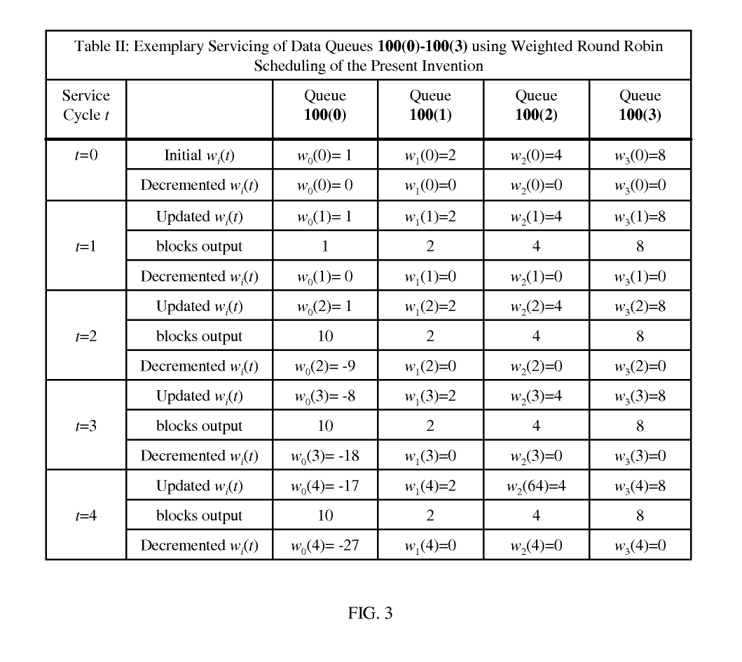

According to the deficit weighted round robin scheduling rules discussed above, a data queue 100(i) will not output a number of blocks that is greater than the data queue's weight. As a result, a decremented weight with wᵢ(t) can never become negative because a data queue 100(i) can never transmit more than its allocation of packets. Thus, in deficit weighted round robin scheduling, each decremented weight wᵢ(t) will always be greater than or equal to zero. A positive decremented weight wᵢ(t−1) that is carried over to the next service cycle t to generate an updated weight wᵢ(t) has been referred to as a “deficit” or “deficit value.” To further understand the servicing of data queues 100(0)-100(n) using deficit weighted round robin scheduling, consider FIG. 2.

FIG. 2 shows Table I, which illustrates an exemplary servicing of four data queues 100(0)-100(3) using deficit weighted round robin scheduling. Suppose for this example that data queues 100(1)-100(3) are filled with 64-byte packets and that each packet corresponds to one 64-byte block. Further, suppose that the first packet stored in data queue 100(0) has one 64-byte block, and the next several blocks stored in data queue 100(0) each have two 64-byte blocks. As shown, the initial weights wᵢ(0) corresponding to data queues 100(0)-100(3) are set to w₀(0)=1 block, w₁(0)=2 blocks, w₂(0)=4 blocks, and w₃(0)=8 blocks, respectively. Since the initial weights wᵢ(t) of data queues 100(0)-100(3) increase in order of ascending index values i, the priority levels of data queues 100(0)-100(3) also increase in order of ascending index values i. During each service cycle t, data queues 100(0)-100(3) are serviced in order of ascending index values i, and thus, data queues 100(0)-100(3) are serviced in order of lowest priority to highest priority.

In the first service cycle t=1, the initial weights w₀(0), w₁(0), w₂(0), and w₃(0) are added to the initialized decremented weights w₀(0)=0, w₁(0)=0, w₂(0)=0, and w₃(0)=0, respectively, to generate updated weights w₀(1)=1, w₁(1)=2, w₂(1)=4, and w₃(1)=8, respectively, for the first service cycle. In servicing data queue 100(0), one 64-byte packet is transferred from data queue 100(0), and weight w₀(1) is decremented by one block to generate decremented weight w₀(1)=0. In servicing data queue 100(1), two 64-byte packets are transferred from data queue 100(1), and weight w₁(1) is decremented by two blocks to generate decremented weight w₁(1)=0. In servicing data queue 100(2), four 64-byte packets are transferred from data queue 100(2), and weight w₂(1) is decremented by four blocks to generate decremented weight w₂(1)=0. In servicing data queue 100(3), eight 64-byte packets are transferred from data queue 100(3), and weight w₃(1) is decremented by eight blocks to generate decremented weight w₃(1)=0.

In the second service cycle t=2, the previous decremented weights w₀(1), w₁(1), w₂(1), and w₃(I) are added to the initial weights w₀(0), w₁(0), w₂(0), and w₃(0), respectively, to generate updated weights w₀(2)=1, w₁(2)=2, w₂(2)=4, and w₃(2)=8, respectively, for service cycle t=2. In servicing data queue 100(0), the next packet to be output has two 64-byte blocks as assumed above; however, w₀(2)=1 block. Since the number of blocks in the packet exceed updated weight w₀(2)=1 block, no packets are output from data queue 100(0) during service cycle t=2, and weight w₀(2) is decremented by zero to generate decremented weight wᵢ(2)=1. In servicing data queues 100(1) to 100(3), two 64-byte packets are transferred from data queue 100(1), four 64-byte packets are transferred from data queue 100(2), and eight 64-byte packets are transferred from data queue 100(3)) to generate decremented weights w₁(2)=0, w₂(2)=0, and w₃(2)=0 for data queues 100(1)-100(3), respectively.

In the third service cycle t=3, the previous decremented weights w₀(2), w₁(2), w₂(2), and w₃(2) are added to the initial weights w₀(0), w₁(0), w₂(0), and w₃(0), respectively, to generate weights w₀(3)=2, w₁(3)=2, w₂(3)=4, and w₃(3)=8, respectively, for service cycle t=3. In servicing data queue 100(0), the next packet to be output has two 64-byte blocks as assumed above. Since the number of blocks in the packet is equal to updated weight w₀(3)=2 blocks, one two-block packet is output from data queue 100(0) during service cycle t=3, and weight w₀(3) is decremented by two to generate decremented weight wᵢ(3)=0. Data queues 100(1) to 100(3) are serviced in a manner similar to that described above in relation to service cycles t=1 and t=2.

One scenario that is not shown in Table I occurs when the number of packets stored in a data queue is less than the number of possible packets that may be output based on the data queue's weight. For example, suppose that during service cycle t=1, only two 64-byte packets are stored in data queue 100(2), which has an updated weight value of w₂(1)=4 blocks. In servicing data queue 100(2), the two packets are output leaving data queue 100(2) empty, and the weight w₂(1) is decremented by two blocks to generate decremented weight w₂(1)=2. In this case, since data queue 100(2) is empty, data queue 100(2) is not serviced in the next service cycle t=2. Further, since data queue 100(2) is not serviced in the next service cycle t=2, decremented weight w₂(1)=2 is reset to zero. When data queue 100(2) is finally serviced, a decremented weight equal to zero is added to initial weight w₂(0) to generate updated weight w₂(t) for that service cycle t.

Alternative to Deficit Weighted Round Robin (WRR) Scheduling

As described above, in deficit weighted round robin scheduling, the total number of blocks in the packets output by each data queue 100(i) in a service cycle t never exceeds the data queue's updated weight wᵢ(t). According to embodiments of the present invention, however, an alternative to deficit weighted round robin scheduling is used in which the total number of blocks in the packets output by each data queue 100(i) in a service cycle is allowed to exceed the data queue's updated weight wᵢ(t).

In particular, in the weighted round robin scheduling of the present invention, in each service cycle t, each data queue 100(i) that is serviced outputs as many packets as it can without exceeding its updated weight wᵢ(t). As each packet gets transmitted, the updated weight wᵢ(t) is decremented based on the number of blocks in that packet. If, after those packets are transmitted, the decremented weight wᵢ(t) is still positive and the data queue 100(i) still has data, then one more packet is transmitted, no matter how many blocks are in the packet. This means that the decremented weight wᵢ(t) for a data queue can become negative. In addition, independent of the updated weight wᵢ(t) at the start of a service cycle t, at least one packet will be transmitted from a data queue 100(1) having data. For a data queue 100(i) having a negative updated weight wᵢ(t) at the start of a service cycle t, the data queue 100(i) will output a single packet, and the weight wᵢ(t) will become even more negative during the service cycle t.

As an example, suppose that (i) a data queue 100(1) has an initial weight wᵢ(0)=3 blocks and (ii) the data queue 100(i) stores two packets, where each packet comprises one 64-byte block (i.e., each packet has a size of 64-bytes). In this case, the data queue outputs the only two packets stored in the data queue. Now suppose that (i) a data queue 100(i) has an initial weight wᵢ(0)=3 blocks and (ii) the data queue stores two packets, where each packet comprises two 64-byte blocks (i.e., each packet has a size of 128-bytes). In this case, the data queue 100(1) outputs the first two-byte packet, resulting in a decremented weight wᵢ(t)=1 block. Outputting the next packet in the data queue 100(1), which has two blocks, would exceed the decremented weight wᵢ(t)=1 block. Since the decremented weight wᵢ(t) is still positive, the next packet is output during the current service cycle t, even though the number of blocks in the next packet (i.e., 2) exceeds the decremented weight wᵢ(t)=1 block.

According to the weighted round robin scheduling rules of the present invention, a data queue 100(i) is allowed to output a number of blocks that is greater than or equal to the data queue's updated weight wᵢ(t) when the data queue 100(i) stores sufficient data. As a result, in the weighted round robin scheduling of the present invention, decremented weights wᵢ(t) can become negative. A negative decremented weight wᵢ(t−1) may be referred to as a “credit” or “credit value” to the extent that prior-art “deficit values” are always non-negative. To further understand the servicing of data queues 100(0)-100(n) using the weighted round robin scheduling of the present invention, consider FIG. 3.

FIG. 3 shows Table II, which illustrates an exemplary servicing of data queues 100(0)-100(3) using weighted round robin scheduling of the present invention. Suppose for this example that data queues 100(1)-100(3) are filled with 64-byte packets and that each packet corresponds to one 64-byte block. Further, suppose that the first packet stored in data queue 100(0) has one 64-byte block, and the next several blocks stored in data queue 100(0) each have ten 64-byte blocks. The first service cycle t=1, is performed in a manner similar to that shown in FIG. 2 to generate decremented weights w₀(1)=0, w₁(1)=0, w₂(1)=0, and w₃(1)=0.

In the second service cycle t=2, updated weights w₀(2)=1, w₁(2)=2, w₂(2)=4, and w₃(2)=8, corresponding to data queues 100(0)-100(3), respectively, are calculated by adding the previous decremented weights w₀(1), wᵢ(1), w₂(1), and w₃(1) to initial weights w₀(0)=1, w₁(0)=2, w₂(0)=4, and w₃(0)=8, respectively. In servicing data queue 100(0), the next packet to be output has ten 64-byte blocks as assumed above; however, w₀(2)=1 block. Even though w₀(2)=1 block, a full ten-block packet is output from data queue 100(0), and weight w₀(2) is decremented by ten to generate decremented weight wᵢ(2)=−9. In servicing data queues 100(1) to 100(3), two 64-byte packets are transferred from data queue 100(1), four 64-byte packets are transferred from data queue 100(2), and eight 64-byte packets are transferred from data queue 100(3)) to generate decremented weights w₁(2)=0, w₂(2)=0, and w₃(2)=0 for data queues 100(1)-100(3), respectively.

In the third service cycle t=3, the previous decremented weights w₀(2), w₁(2), w₂(2), and w₃(2) are added to the initial weights w₀(0), w₁(0), w₂(0), and w₃(0), respectively, to generate updated weights w₀(3)=−8, w₁(3)=2, w₂(3)=4, and w₃(3)=8, respectively, for service cycle t=3. In servicing data queue 100(0), the next packet to be output has ten 64-byte blocks as assumed above. Even though w₀(3)=−8 blocks, a full ten-block packet is output from data queue 100(0), and weight w₀(3) is decremented by ten to generate decremented weight wᵢ(3)=−18. Data queues 100(1) to 100(3) are serviced in a manner similar to that described above in relation to service cycles t=1 and t=2. The fourth service cycle t=4 is performed in a similar manner to generate decremented weights w₀(4)=−27, w₁(4)=0, w₂(4)=0, and w₃(4)=0 for data queues 100(0)-100(3), respectively.

As shown in Table II, the weights wᵢ(t) change from one service cycle to the next. However, to maintain the priority established by the initial weights wᵢ(0), the ratio of the number of blocks output by each data queue 100(i) in a service cycle t to the number of blocks output by each other data queue 100(i) in the service cycle t should not change. In other words, higher-priority data queues should continue to output a greater number of blocks than lower-priority data queues in proportion to the ratios of the initial weights wᵢ(0). For example, in Table II, the ratios of initial weight w₀(0) to initial weights w₁(0), w₂(0), and w₃(0) are 1:2, 1:4, and 1:8, respectively. However, as shown in Table II, for service cycles t=2, t=3, and t=4, (i.e., when the decremented weights w₀(t) of data queue 100(0) are negative), data queue 100(0) outputs more blocks per service cycle t than each of the higher-priority data queues 100(1)-100(3). Thus, for this period of time, a scheduling error occurs in which the ratios of the number of blocks transferred from data queue 100(0) to the number of blocks output by each other data queue 100(1)-100(3) have changed to 10:2, 10:4, and 10:8, respectively.

One relatively simple solution to this problem, which ensures that decremented weights wᵢ(t) do not turn negative in the first place, is to select the initial weights wᵢ(0) based on the maximum packet size of the application. For instance, suppose that the network processor discussed above is implemented in an Ethernet application in which the maximum packet size is 9,216 bytes. Further, suppose that each block contains 64 bytes, such that there are 9,216/64=144 blocks in each packet having the maximum packet size. Expanding on the examples above, initial weight w₀(0) of data queue 100(0) may be set to 1×144=144, initial weight w₁(0) of data queue 100(1) may be set to 2×144=288, initial weight w₂(0) of data queue 100(2) may be set to 4×144.576, and initial weight w₃(0) of data queue 100(3) may be set to 8×144=1,152, such that the ratio of each data queue's initial weight wᵢ(t) to each other data queue's initial weight wᵢ(t) is the same as in the examples of Table I and II.

While selecting the initial weights wᵢ(0) based on the maximum packet size prevents the decremented weights iv (t) from turning negative, this method suffers from other problems. For example, this method may result in frequent data queue underrun, wherein the number of blocks stored in, and consequently transferred from, a data queue is less than the data queue's updated weight wᵢ(t). Data queue underrun is more likely to occur when the size of the packets stored in a data queue are relatively small. For example, suppose that a data queue 100(3), having an initial weight w₃(0)=1,152, stores 64-byte packets, each containing one 64-byte block. In order to prevent underrun, data queue 100(3) would have to store 1,152 blocks (i.e., 1,152 data packets) every service cycler. However, if data queue 100(3) stores 9,216-byte packets, data queue 100(3) would only have to store eight packets (1,152 blocks/(9,216-byte packet/64-byte block)=8 packets) to prevent data queue underrun. When data queue underrun occurs, the ratios of the number of blocks output by a data queue to the numbers of blocks output by each other data queue changes, resulting in scheduling inaccuracy.

In addition, setting the initial weights wᵢ(t) to relatively large values increases the latency between service cycles due to the increased numbers of blocks that need to be output by each data queue. This can be problematic for time-sensitive applications.

Adjusting Negative Weights in the Weighted Round Robin (WRR) Scheduling of the Present Invention

As shown in Table II of FIG. 3, the weighted round robin scheduling of the present invention does not work that well in block-based network processors when the size of the packets stored in a data queue changes. In such a case, the ratios of the numbers of blocks output by each data queue in a service cycle t to the numbers of blocks output by each other data queue in the service cycle t changes. As a result, the data queues do not output blocks according to the priority set by their initial weights wᵢ(0).

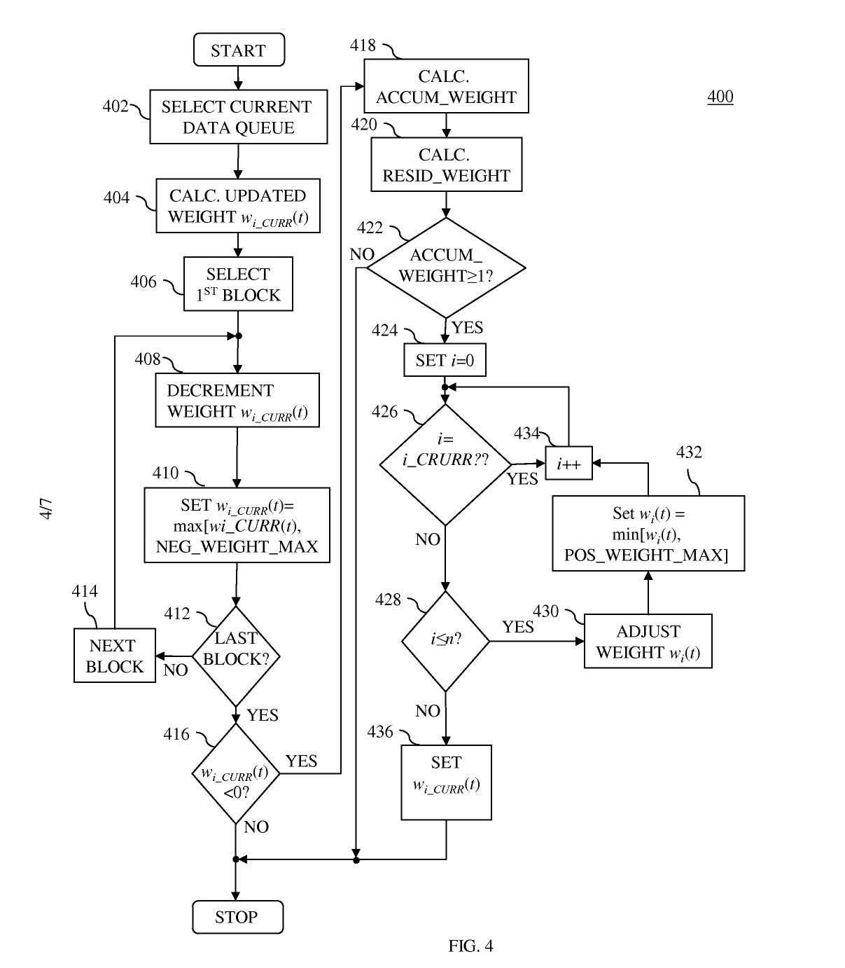

Rather than setting the initial weights wᵢ(0) based on the maximum packet size as discussed above, the initial weights wᵢ(0) may be set to their desired, non-elevated values. Then, after a data queue outputs a number of blocks that is greater than the data queue's updated weight wᵢ(1) (i.e., a negative decremented weight wᵢ(t) is generated), the weights wᵢ(t) corresponding to the remaining data queues may be increased based on the magnitude of the negative decremented weight wᵢ(t) to restore, in subsequent service cycles, the priority that was set by the initial weights wᵢ(0). In other words, the weights wᵢ(t) of the remaining data queues may be adjusted to compensate for the loss of priority in previous service cycles, such that, in subsequent service cycles, the remaining data queues output additional blocks, essentially making up for the priority that was lost in previous service cycles. Thus, the ratios of the total numbers of blocks output by the data queues over several service cycles will be the same as the ratio of initial weights wᵢ(t). To further understand one method for adjusting decremented weights wᵢ(t), consider FIG. 4.

FIG. 4 shows a simplified flow diagram 400 of a method according to one embodiment of the present invention that may be used to adjust weights wᵢ(t) when a decremented weight becomes negative. Flow diagram 400 may be implemented by a scheduler such as scheduler 102 of FIG. 1, and may be used to adjust weights wᵢ(t) of data queues such data queues 100(0) to 100(n). Flow diagram 400 is performed one time for each data queue 100(i) in which one or more data packets are stored during each service cycle 1. Upon startup, a data queue 100(i), herein referred to as current data queue 100(i_CURR), is selected for transferring data packets (step 402). In step 404, the updated weight wᵢ_{_{—}}_{CURR}(t) corresponding to the current queue 100(i_CURR) for the current service cycle t is calculated as shown in Equation (1) below:

wᵢ_{_{—}}_{CURR}(t)=wᵢ_{_{—}}_{CURR}(0)+wᵢ_{_{—}}_{CURR}(t−1) (1)

where wᵢ_{_{—}}_{CURR}(0) is an initial weight corresponding to the current data queue 100(i_CURR) and wᵢ_{_{—}}_{CURR}(t−1) is a previous decremented weight corresponding to the current data queue from the previous service cycle (t−1). Note that, in service cycle t=1, previous decremented weight wᵢ_{_{—}}_{CURR}(t−1) is initialized to zero.

In general, after calculating updated weight wᵢ_{_{—}}_{CURR}(t), steps 406, 408, 412, and 414 are performed to decrement updated weight wᵢ_{_{—}}_{CURR}(t) by one for each block of each packet that is transferred from the current data queue 100(i_CURR). Further, steps BF and 410 are performed to ensure that weight wᵢ_{_{—CURR}}(t) does not fall below a negative threshold value NEG_WEIGHT_MAX. The magnitude of negative threshold value NEG_WEIGHT_MAX may be calculated by multiplying (i) the number of blocks in the maximum packet size for the application (e.g., 9,216 bytes in max packet size/64 bytes per block=144 blocks) by (ii) a specified number of packets, which may be selected empirically (e.g., may be determined by the operator based on observing the traffic distribution).

In step 406, a first block of the first data packet in the head of the current data queue is selected for transfer. Updated weight wᵢ_{_{—}}_{CURR}(t) is then decremented by one (step 408) for the first block. The resulting, decremented weight wᵢ_{_{—}}_{CURR}(t) is set equal to the maximum of the value of decremented weight wᵢ_{_{—}}_{CURR}(t) and negative threshold value NEG_WEIGHT_MAX (step 410) as shown in Equation (2) below:

wᵢ_{_{—}}_{CURR}(t)=max└wᵢ_{_{—}}_{CURR}(t),NEG_WEIGHT_MAX┘ (2)

In step 412, a determination is made as to whether or not the block being transferred is the last block of the last packet that is to be transferred from current data queue 100(i_CURR) in the current service cycle t. This decision is made based on the rules of discussed above in relation to the weighted round robin scheduling of the present invention. Thus, step 412 determines whether the block being transferred is the last block of the packet being transferred. If the block being transferred is not the last of the packet being transferred, then processing proceeds to the next block (step 414).

If the block being transferred is the last block of the packet being transferred, then step 412 determines whether (i) the decremented weight wᵢ(t) is greater than zero and (ii) there are packets remaining in current data queue 100(i_CURR). If the decremented weight wᵢ(t) is greater than zero and there are packets remaining in current data queue 100(i_CURR), then processing proceeds to the first block of the next packet (step 414). If, on the other hand, the decremented weight wᵢ(t) is not greater than zero or there are no packets remaining in current data queue 100(i_CURR), then no additional blocks are output and processing proceeds step 416 to determine whether or not the decremented weight wᵢ_{_{—}}_{CURR}(t) is negative. If the decremented weight wᵢ_{_{—}}_{CURR}(t) is not less than zero, then processing for the current data queue 100(i_CURR) is terminated. If, on the other hand, the decremented weight wᵢ_{_{—}}_{CURR}(t) is less than zero, then steps 418 to 436 are performed as discussed below.

In step 418, an accumulated weight value ACCUM_WEIGHT, which is used in step 422 to determine whether or not to adjust the weights cᵢ(t) of all of the data queues 100, is calculated for the ith data queue according to Equation (3):

$$ACCUM\_WEIGHT = \frac{\vert {w}_{i \_ CURR} ( t ) \vert}{( ( {\sum }_{i = 0}^{n} {w}_{i} ( 0 ) ) - {w}_{i \_ CURR} ( 0 ) )} \qquad ( 3 )$$

In step 420, a residual weight value RESID_WEIGHT, which is used in the adjusting of all of the weights wᵢ(1), is calculated for the current data queue 100(i_CURR) as shown in Equation (4) below:

$$RESID\_WEIGHT = \vert {w}_{i \_ CURR} ( t ) \vert \% ( ( {\sum }_{i = 0}^{n} {w}_{i} ( 0 ) ) - {w}_{i \_ CURR} ( 0 ) ) \qquad ( 4 )$$

where % indicates the modulo operation.

In general, the decision in step 422 of whether or not to adjust the weights wᵢ(t) of all of the data queues 100 is made based on whether the magnitude |wᵢ_{_{—}}_{CURR}(t)| of the negative weight wᵢ_{_{—}}_{CURR}(t) for the current data queue 100(i_CURR) is sufficiently large for adjusting the remaining data queues. The magnitude |wᵢ_{_{—}}_{CURR}(t)| is sufficiently large when the magnitude |wᵢ_{_{—}}_{CURR}(t)| is greater than or equal to a sum of all initial weights wᵢ(0), excluding the initial weight wᵢ_{_{—}}_{CURR}(0) for the current data queue

$$100 ( i\_CURR ) ( i . e . , \vert {w}_{i \_ CURR} ( t ) \vert \geq ( {\sum }_{i = 0}^{n} {w}_{i} ( 0 ) ) - {w}_{i \_ CURR} ( 0 ) ) .$$

To implement the decision in step 422, the accumulated weight value ACCUM_WEIGHT is compared to a value of one. If the accumulated weight value ACCUM_WEIGHT is greater than or equal to one, then the weights wᵢ(t) of all data queues 100, other than current data queue 100(i_CURR), are increased in steps 424 to 428 by an amount proportional to |wᵢ_{_{—}}_{CURR}(t)|−RESID_WEIGHT as discussed below. Further, the weight wᵢ_{_{—}}_{CURR}(t) of current data queue 100(i_CURR) is set equal to the residual weight value RESID_WEIGHT as discussed below in relation to step 436. If, on the other hand, the accumulated weight value ACCUM_WEIGHT is less than one, then the weights wᵢ(t) are not adjusted. In this case, processing for the current data queue 100(i_CURR) is terminated.

Note that the determination in step 422 as to whether or not the magnitude |wᵢ_{_{—}}_{CURR}(t)| is sufficiently large could also be performed by simply comparing the magnitude |wᵢ_{_{—}}_{CURR}(t)| to the sum of the initial weights wᵢ(0), excluding the initial weight wᵢ_{_{—}}_{CURR}(0) for the current data queue 100(i_CURR) (i.e., the denominator of Equation (3)). If the magnitude |wᵢ_{_{—}}_{CURR}(t)| is greater than or equal to the denominator of Equation (3), then the weights wᵢ(t) of the data queues 100 are adjusted. Otherwise, the weights wᵢ(t) are not adjusted.

In step 424, the weight w₀(t) corresponding to data queue index i=0 (i.e., data queue 100(0)) is selected for adjustment. In step 426, a determination is made as to whether index value i=i_CURR. If i=i_CURR, then, in step 434, the data queue index value i is incremented by one to select the next weight w₁(t) corresponding to the next data queue 100(1). In other words, steps 426 and 434 are performed to skip updating of the weight wᵢ_{_{—}}_{CURR}(t) for the current data queue 100(i_CURR), which is performed in later in step 436.

if weight w₀(t) does not correspond to the current data queue 100(i_CURR), then in step 428, a determination is made as to whether or not data queue index value i is less than or equal to the last data queue index number n. If data queue index value i is less than or equal to n, then an adjusted weight wᵢ(t) for data queue 100(i) is calculated in step 430 according to Equation (5) as follows:

$${w}_{i} ( t ) = [ \begin{matrix}\vert {w}_{i \_ CURR} ( t ) \vert - \\ RESID\_WEIGHT\end{matrix} ] \times [ \frac{( \begin{matrix}\vert {w}_{i \_ CURR} ( t ) \vert - \\ RESID\_WEIGHT\end{matrix} )}{{w}_{i \_ CURR} ( 0 )} ] \times [ \frac{{w}_{i} ( 0 )}{( \begin{matrix}( {\sum }_{i = 0}^{n} {w}_{i} ( 0 ) ) - \\ {w}_{i \_ CURR} ( 0 )\end{matrix} )} ] \qquad ( 5 )$$

where wᵢ(0) is the initial weight of the data queue 100(i) being adjusted.

In step 432, the adjusted weight wᵢ(t) is set equal to the minimum of the value of the adjusted weight wᵢ(t) and a positive weight threshold POS_WEIGHT_MAX as shown in Equation (6) below:

wᵢ(t)=min[wᵢ(t),POS_WEIGHT_MAX] (6)

Positive weight threshold POS_WEIGHT_MAX, which is used to prevent the adjusted weight wᵢ(t) from becoming too large, may be calculated by multiplying (i) the maximum number of blocks in a packet for the application (e.g., 9,216 bytes in max packet size/64 bytes per block=144 blocks) by (ii) the specified number of packets referred to above in relation to the negative weight threshold NEG_WEIGHT_MAX.

In step 434, data queue index value i is incremented by one, and steps 426-434 are repeated until, in step 428, the data queue index value i is greater than n, indicating that all data queues 100 have been considered. After all data queues 100 have been considered, decremented weight wᵢ_{_{—}}_{CURR}(t) corresponding to current data queue 100(i_CURR) is set as shown in Equation (7) below:

wᵢ_{_{—}}_{CURR}(t)=−RESID_WEIGHT (7)

Processing is then terminated for current data queue 100(i_CURR). Flow diagram 400 may then be performed for the next data queue 100(i) until all of the data queues 100 have been processed.

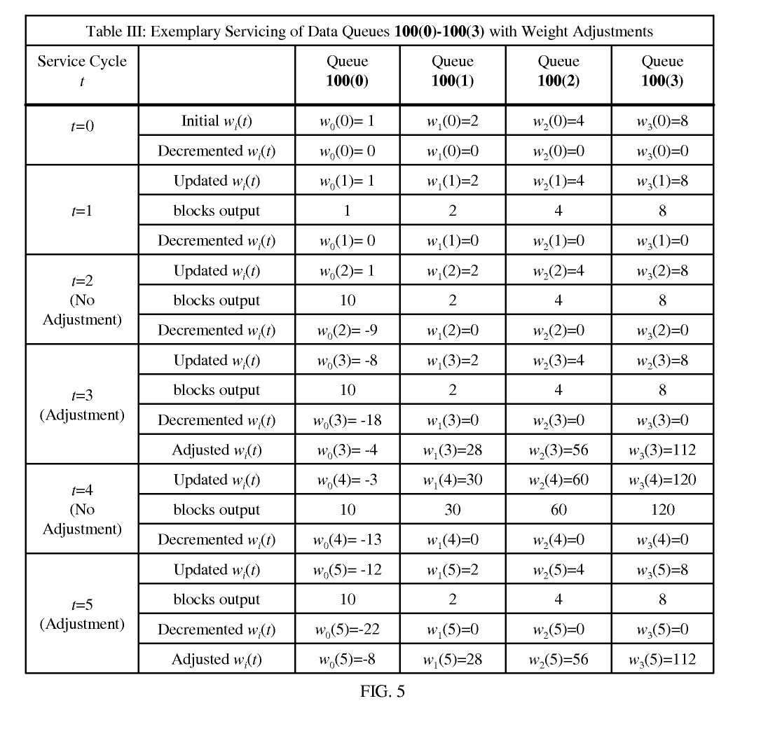

FIG. 5 shows Table III, which illustrates an exemplary adjustment of weights wᵢ(t) according to one embodiment of the present invention. Table III is an extension of the exemplary servicing of data queues 100(0)-100(3) in Table II of FIG. 3 that shows the adjustment of weights wᵢ(t). As shown, in the first and second service cycles t=1 and t=2, data queues 100(0)-100(3) are serviced in the exact same manner as in Table II of FIG. 3, to generate decremented weights w₀(2)=−9, w₁(2)=0, w₂(2)=0, and w₃(2)=0 in service cycle t=2: After servicing data queue 100(0) in service cycle t=2, the magnitude of decremented weight w₀(2) (i.e., the negative weight) is less than the sum of the initial weights wᵢ(0) of data queues 100(1)-100(3) (i.e., |−9|<(2+4+8=14)). Thus, the weights wᵢ(t) corresponding to data queues 100(0)-100(3) are not adjusted during service cycle t=2.

In service cycle t=3, data queues 100(0)-100(3) are serviced in the same manner as in service cycle t=3 of Table II of FIG. 3. At the end of service cycle t=3, decremented weights w₀(3)=−18, w₁(3)=0, w₂(3)=0, and w₃(3)=0 would be generated for data queues 100(0)-100(3), respectively, if adjustment of the weights were not performed. However, since the magnitude of decremented weight w₀(3) (i.e., the negative weights) is greater than or equal to the sum of the initial weights w₁(0) of data queues 100(1)-100(3) (i.e., |−18|>(2+4+8=14)), the weights wᵢ(3) of data queues 100(0)-100(3) are adjusted during service cycle t=3 as shown in Table III.

To adjust the weights wᵢ(3) of data queues 100(1)-100(3), a residual weight value RESID_WEIGHT is calculated as shown above in Equation (4) (i.e., |−18|%14=4). Then, RESID_WEIGHT is used to calculate the adjusted weights wᵢ(3) for each of data queues 100(1)-100(3) as shown in Equation (5) above. Thus, w₁(3)=[|−18|−4]×[(|−18|−4)/1]×[2/(2+4+8)]=28, w₂(3)=[|−18|−4]×[(|−18|−4)/1]×[4/(2+4+8)]=56, and w₃(3)=[|−18|−4]×[(|−18|−4)/1]×[8/(1+2+4+8−1)]=112. Further, adjusted weight w₀(3) for data queue 100(0) is set equal to −RESID_WEIGHT as shown above in Equation (6).

In service cycle t=4, adjusted weights w₀(3), w₁(3), w₂(3), and w₃(3) are added to initial weights w₀(0), w₁(0), w₂(0), and w₃(0), respectively, to generate updated weights w₀(4)=−3, w₁(4)=30, w₂(4)=60, and w₃(4)=120, respectively. In servicing data queues 100(0)-100(3), one ten-block packet is transferred from data queue 100(0) resulting in decremented weight w₀(4)=−13, 30 blocks are transferred from data queue 100(1) resulting in decremented weight w₁(4)=0, 60 blocks are transferred from data queue 100(2) resulting in decremented weight w₂(4)=0, and 120 blocks are transferred from data queue 100(3) resulting in decremented weight w₃(4)=0. Since, in service cycle t=4, the magnitude of decremented weight w₀(4) (i.e., the negative weight) is less than the sum of the initial weights w₁(0) of data queues 100(1)-100(3) (i.e., |−13|<(2+4+8=14)), the weights wᵢ(4) of data queues 100(0)-100(3) are not adjusted during service cycle t=4.

In service cycle t=5, decremented weights w₀(4), w₁(4), w₂(4), and w₃(4) are added to initial weights w₀(0), w₁(0), w₂(0), and w₃(0), respectively, to generate updated weights w₀(5)=−12, w₁(5)=2, w₂(5)=4, and w₃(5)=8, respectively. In service cycle t=5, data queue 100(0) again outputs one ten-block packet resulting in decremented weight w₀(5)=−22, data queue 100(1) outputs two blocks resulting in decremented weight w₁(5)=0, data queue 100(2) outputs four blocks resulting in decremented weight w₂(5)=0, and data queue 100(3) outputs eight blocks resulting in decremented weight w₃(5)=0. However, since the magnitude of decremented weight w₀(5) (i.e., the negative weight) is greater than or equal to the sum of the initial weights wᵢ(0) of data queues 100(1)-100(3) (i.e., |−22|>(2+4+8=14)), the decremented weights wᵢ(5) of data queues 100(0)-100(3) are adjusted during service cycle t=5 as shown in Table III.

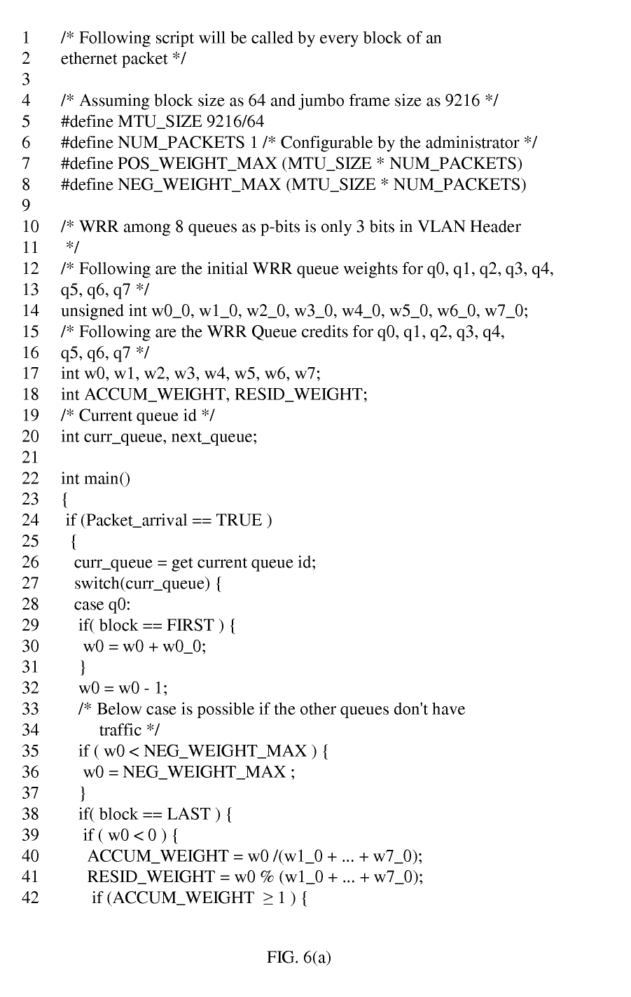

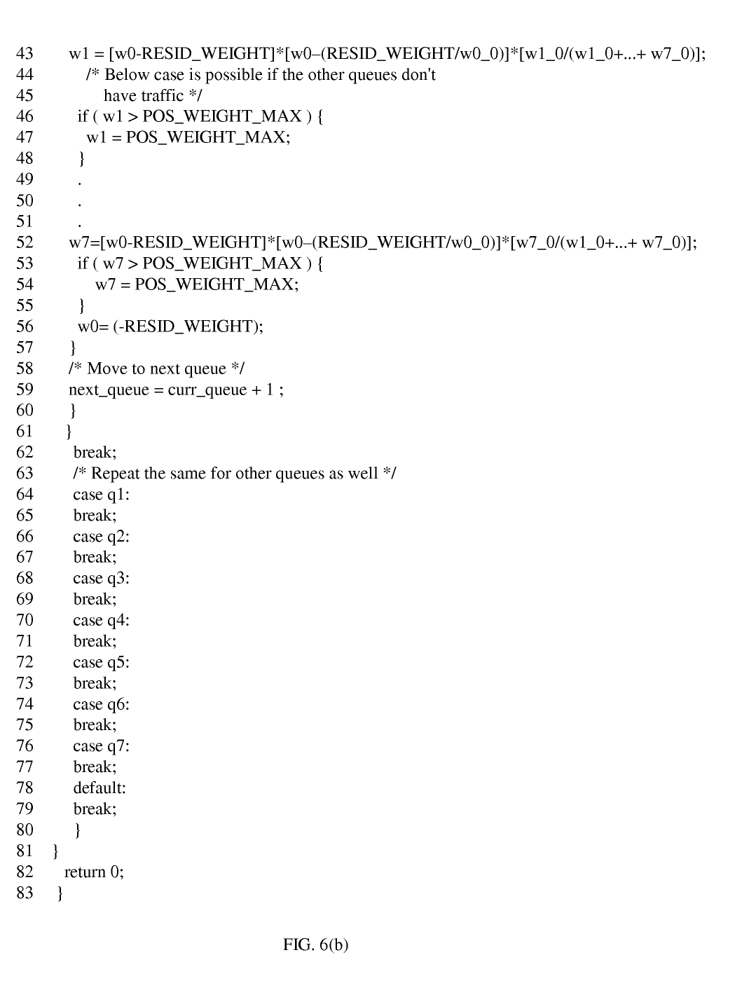

FIGS. 6(a) and 6(b) show pseudocode CA according to one embodiment of the present invention that may be used to adjust data queue weights wᵢ(t) when a decremented weight becomes negative. As indicated in lines 1-2, pseudocode CA is performed on a block-by-block basis. In lines 4-8, initial parameters are set such as the maximum transmission unit size (i.e., the maximum number of blocks in a packet) and the specified number of packets NUM_PACKETS used in determining the maximum negative and positive weight thresholds NEG_WEIGHT_MAX and POS_WEIGHT_MAX as described above. In lines 10-18, additional initial parameters are set such as (i) the initial queue weights (i.e., w0_0, . . . , w7_0), (ii) the updated queue weights (i.e., w0, . . . , w7), (iii) the initial accumulated weight value ACCUM_WEIGHT, and (iv) the residual accumulated weight value RESID_WEIGHT, the latter three of which may be initialized to zero.

In line 24, a determination is made as to whether or not a packet is being stored in one of the data queues. If a packet is being stored, then the data queue index value (i.e., id) is determined, and the data queue having the determined index value is selected (line 26 and 27). The lines of code corresponding to the selected data queue are then implemented. For example, lines 28-62 are implemented when data queue 0 is selected, lines 64-65 are implemented when data queue 1 is selected, lines 66-67 are implemented when data queue 2 is selected, and so on. Note that, to simplify FIG. 6, only two lines of code are shown for each of data queues 1-7. However, in practice, each of data queues 1 to 7 would have lines of code similar to that shown in lines 28-62, albeit modified appropriately for data queues 1 to 7.

Suppose for this discussion that data queue 0 is selected. If the block being output is the first block to be output from data queue 0 during the current service cycle t, then weight w0 for data queue q0 is initialized as shown in line 30. If the block being output is not the first block, then weight w0 from the previous iteration of pseudo code CA is used. In line 32, the weight w0 is decremented by one for the block that is being transferred. In line 35, weight w0 is compared to the negative weight threshold NEG_WEIGHT_MAX. If weight w0 is less than NEG_WEIGHT_MAX, then weight w0 is set equal to NEG_WEIGHT_MAX (line 36), otherwise weight w0 is not changed as shown in Equation (2) above.

If the block being output is the last block to be output from data queue 0 during the current service cycle 1, then a determination is made in line 39 as to whether or not weight w0 is negative. If weight w0 is negative, then accumulated weight value ACCUM_WEIGHT and residual weight value RESID_WEIGHT are calculated in lines 40 and 41, respectively, using Equations (3) and (4) above, respectively. The accumulated weight value ACCUM_WEIGHT is compared to a value of one (line 42), and if ACCUM_WEIGHT is greater than or equal to one, then weights w0 to w7 are adjusted in lines 43 to 56. Otherwise, weights w0 to w7 are not adjusted.

If a determination is made to adjust weights w0 to w7, then weight w1 is (i) adjusted in line 43 using Equation (5), (ii) compared to the positive weight threshold POS_WEIGHT_MAX as shown in line 44, and (ii) set equal to positive weight threshold POS_WEIGHT_MAX in line 47 as shown in Equation (6) if w2 exceeds POS_WEIGHT_MAX. This process is repeated for weights w2 to w7 as shown in lines 49-55. After weights w1 to w7 have been calculated, weight w0 is set equal to −RESID_WEIGHT as shown in line 56. Once all weights have been adjusted, the next data queue is selected for transferring data (line 59).

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values stored in a non-transitory recording medium generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A processor-implemented method for servicing data queues in a weighted round robin (WRR) manner, the method comprising:
(a) transmitting one or more packets from each of two or more data queues having data and decrementing a current weight for each data queue;
(b) determining that a current weight for a first data queue has a negative value; and
(c) adjusting the current weight for at least one other data queue based on a magnitude of the current weight for the first data queue.

2. The processor-implemented method of claim 1, further comprising (d) adjusting the current weight for the first data queue.

3. The processor-implemented method of claim 1, wherein step (a) comprises, for each data queue:
(a1) generating, before transmitting the one or more packets, the current weight for the data queue by adding an initial weight for the data queue to a prior weight for the data queue;
(a2) transmitting the one or more packets based on the data queue's current weight; and
(a3) decrementing the data queue's current weight based on the one or more packets transmitted.

4. The processor-implemented method of claim 3, wherein:
each data queue's current weight represents a desired number of data blocks to be transmitted from the data queue, wherein each packet comprises an integer number of data blocks; and
step (a3) comprises decrementing the data queue's current weight by one for each data block of each packet transmitted from the data queue.

5. The processor-implemented method of claim 4, wherein at least one data queue stores at least two packets having different numbers of data blocks.

6. The processor-implemented method of claim 4, wherein steps (a2) and (a3) comprise:
(i) transmitting one packet from the data queue;
(ii) decrementing the data queue's current weight based on the number of data blocks in the one packet; and
(iii) repeating steps (i) and (ii) if the data queue's decremented current weight is positive and if the data queue has another packet available to transmit.

7. The processor-implemented method of claim 3, wherein step (a2) comprises transmitting at least one packet from the data queue independent of the value of the data queue's current weight.

8. The processor-implemented method of claim 1, wherein:
each data queue is assigned an initial weight; and
step (c) comprises determining to adjust the current weight for the at least one other data queue only if the magnitude of the current weight for the first data queue exceeds a sum of the initial weights for the at least one other data queue.

9. The processor-implemented method of claim 8, wherein:
the two or more data queues comprise n data queues i, wherein i=0, . . . , n;
step (c) comprises adjusting the weight for the at least one other data queue by an amount proportional to:
$$[ \begin{matrix}\vert {w}_{i \_ CURR} ( t ) \vert - \\ RESID\_CREDIT\end{matrix} ] \times [ \frac{( \begin{matrix}\vert {w}_{i \_ CURR} ( t ) \vert - \\ RESID\_CREDIT\end{matrix} )}{{w}_{i \_ CURR}} ( 0 ) ] \times [ \frac{{w}_{i} ( 0 )}{( \begin{matrix}( {\sum }_{i = 0}^{n} {w}_{i} ( 0 ) ) - \\ {w}_{i \_ CURR} ( 0 )\end{matrix} )} ] ,$$
wherein:
wᵢ_{_{—}}_{CURR}(t) is the weight for the first data queue;
wᵢ_{_{—}}_{CURR}(0) is the initial weight for the first data queue;
wᵢ(0) is the initial weight for the at least one other data queue;
$$( {\sum }_{i = 0}^{n} {w}_{i} ( 0 ) ) - {w}_{i \_ CURR} ( 0 )$$
is the sum of the initial weights for the at least one other data queue; and
$$RESID\_CREDIT = \vert {w}_{i \_ CURR} ( t ) \vert \% ( ( {\sum }_{i = 0}^{n} {w}_{i} ( 0 ) ) - {w}_{i \_ CURR} ( 0 ) ) ,$$
wherein:
“%” indicates a modulo operation.

10. The processor-implemented method of claim 8, wherein:
the two or more data queues comprise n data queues i, wherein i=0, . . . , n; and
step (c) further comprises adjusting the weight for the first data queue by an amount proportional to:
$$- \vert {w}_{i \_ CURR} ( t ) \vert \% ( ( {\sum }_{i = 0}^{n} {w}_{i} ( 0 ) ) - {w}_{i \_ CURR} ( 0 ) ) ,$$
wherein:
wᵢ_{_{—}}_{CURR}(t) is the weight for the first data queue;
wᵢ_{_{—}}_{CURR}(0) is the initial weight for the first data queue;
wᵢ(0) is the initial weight for the at least one other data queue;
$$( {\sum }_{i = 0}^{n} {w}_{i} ( 0 ) ) - {w}_{i \_ CURR} ( 0 )$$
is the sum of the initial weights for the at least one other data queue; and
“%” indicates a modulo operation.

11. A processor that services data queues in a weighted round robin (WRR) manner, wherein the processor is adapted to:
transmit one or more packets from each of two or more data queues having data and decrement a current weight for each data queue;
determine that a current weight for a first data queue has a negative value; and
adjust the current weight for at least one other data queue based on a magnitude of the current weight for the first data queue.

12. The processor of claim 11, wherein the processor is further adapted to adjust the current weight for the first data queue.

13. The processor of claim 11, wherein the processor is adapted to, for each data queue:
generate, before transmitting the one or more packets, the current weight for the data queue by adding an initial weight for the data queue to a prior weight for the data queue;
transmit the one or more packets based on the data queue's current weight; and
decrement the data queue's current weight based on the one or more packets transmitted.

14. The processor of claim 13, wherein:
each data queue's current weight represents a desired number of data blocks to be transmitted from the data queue, wherein each packet comprises an integer number of data blocks; and
the processor is adapted to decrement the data queue's current weight by one for each data block of each packet transmitted from the data queue.

15. The processor of claim 14, wherein at least one data queue stores at least two packets having different numbers of data blocks.

16. The processor of claim 14, wherein the processor is adapted to:
(i) transmit one packet from the data queue;
(ii) decrement the data queue's current weight based on the number of data blocks in the one packet; and
(iii) repeat steps (i) and (ii) if the data queue's decremented current weight is positive and if the data queue has another packet available to transmit.

17. The processor of claim 13, wherein the processor is adapted to transmit at least one packet from the data queue independent of the value of the data queue's current weight.

18. The processor of claim 11, wherein:
each data queue is assigned an initial weight; and
the processor is adapted to determine to adjust the current weight for the at least one other data queue only if the magnitude of the current weight for the first data queue exceeds a sum of the initial weights for the at least one other data queue.

19. The processor of claim 18, wherein:
the two or more data queues comprise n data queues i, wherein i=0, . . . , n;
the processor is adapted to adjust the weight for the at least one other data queue by an amount proportional to:
$$[ \begin{matrix}\vert {w}_{i \_ CURR} ( t ) \vert - \\ RESID\_CREDIT\end{matrix} ] \times [ \frac{( \begin{matrix}\vert {w}_{i \_ CURR} ( t ) \vert - \\ RESID\_CREDIT\end{matrix} )}{{w}_{i \_ CURR} ( 0 )} ] \times [ \frac{{w}_{i} ( 0 )}{( \begin{matrix}( {\sum }_{i = 0}^{n} {w}_{i} ( 0 ) ) - \\ {w}_{i \_ CURR} ( 0 )\end{matrix} )} ] ,$$
wherein:
wᵢ_{_{—}}_{CURR}(t) is the weight for the first data queue;
wᵢ_{_{—}}_{CURR}(0) is the initial weight for the first data queue;
wᵢ(0) is the initial weight for the at least one other data queue;
$$( {\sum }_{i = 0}^{n} {w}_{i} ( 0 ) ) - {w}_{i \_ CURR} ( 0 )$$
is the sum of the initial weights for the at least one other data queue; and
$$RESID\_CREDIT = \vert {w}_{i \_ CURR} ( t ) \vert \% ( ( {\sum }_{i = 0}^{n} {w}_{i} ( 0 ) ) - {w}_{i \_ CURR} ( 0 ) ) .$$
wherein:
“%” indicates a modulo operation.

20. The processor of claim 18, wherein:
the two or more data queues comprise n data queues i, wherein i=0, . . . , n; and
the processor is adapted to adjust the weight for the first data queue by an amount proportional to:
$$- \vert {w}_{i \_ CURR} ( t ) \vert \% ( ( {\sum }_{i = 0}^{n} {w}_{i} ( 0 ) ) - {w}_{i \_ CURR} ( 0 ) ) ,$$
wherein:
wᵢ_{_{—}}_{CURR}(t) is the weight for the first data queue;
wᵢ_{_{—}}_{CURR}(0) is the initial weight for the first data queue;
wᵢ(0) is the initial weight for the at least one other data queue;
$$( {\sum }_{i = 0}^{n} {w}_{i} ( 0 ) ) - {w}_{i \_ CURR} ( 0 )$$
wᵢ_{_{—}}_{CURR}(t) is the sum of the initial weights for the at least one other data queue; and
“%” indicates a modulo operation.
